(19) United States
(12) Patent Application Publication
(10) Pub. No.: US 2018/0260876 A1
(43) Pub. Date: Sep. 13, 2018

(54) AUTOMATED DATABOT SYSTEM

(71) Applicant: Walmart Apollo, LLC, Bentonville, AR (US)

(72) Inventors: David M. Graham, Bentonville, AR (US); Jeremy O. Williams, Bentonville, AR (US); Rebecca Hilliard, Rogers, AR (US)

(21) Appl. No.: 15/881,678

(22) Filed: Jan. 26, 2018

Related U.S. Application Data
(60) Provisional application No. 62/470,140, filed on Mar. 10, 2017.

(51) Int. Cl. G06Q 30/06; H04L 9/32; G06K 9/00; G06K 9/20; G06K 9/78

(52) U.S. Cl. CPC G06Q 30/0631; H04L 9/32; G06K 9/78; G06K 9/209; G06K 9/00771

(57) ABSTRACT

A system and method are provided for automated value negotiations. A databot analyzes data associated with a user from a plurality of sources to identify an activity of the user. The databot makes a prediction regarding a product of potential interest to the user based on the activity and user preferences. The product may be a physical item or a service. The databot autonomously negotiates with one or more providers of the product to obtain a negotiated rate for the product. The databot negotiates for the product alone or in collaboration with one or more other databots.

### BACKGROUND

In a competitive market, providers of products or services attract customers by providing better options in some regard, whether it be more variety of options, better quality, better service, or a better value than another provider. However, identifying the best provider of a particular product or service may often be challenging and time consuming. In addition, a consumer may have insufficient knowledge or experience with one or more products or services, which would be helpful or beneficial if made available. In an environment where vast amounts of information are available, options for identifying ways to obtain a product or service that is beneficial are needed.

### SUMMARY

Examples of the disclosure provide a system for automatically performing value negotiations. A set of sensors monitor an environment within a detection zone. A databot device is communicatively coupled to the set of sensors. The databot device obtains sensor data from the set of sensors. The databot device analyzes the sensor data to identify a user activity or user interest. The databot device generates a prediction of at least one product of interest to the user based on the identified user activity or user interest and a set of preferences. The at least one predicted product of interest is a physical item or a service. The databot device automatically negotiates with at least one provider of the at least one predicted product of interest via a network. The databot device obtains a negotiated transaction value for the at least one predicted product of interest.

Other examples provide a method for autonomously negotiating with a provider to obtain a product. A databot analyzes a plurality of data sources associated with a user to identify at least one activity of interest to a user. The databot receives a set of preferences associated with at least one of the user or the at least one identified activity. The databot identifies at least one product associated with the at least one identified activity. The at least one identified product is a physical item or a service. The databot automatically negotiates with at least one provider of the at least one identified product via a network. The databot negotiates for provision of the at least one identified product to the user at a negotiated rate.

Still other examples of the disclose provide one or more computer storage devices storing computer-executable instructions stored for autonomously negotiating for provision of products from a provider. The computer-executable instructions are executed by a computer to monitor a plurality of data sources associated with a user to identify at least one product of interest to a user; identify at least one provider associated with the identified product of interest; automatically negotiate with the at least one identified provider of the at least one identified product of interest to obtain a negotiated transaction value for the at least one identified product; and output the obtained negotiated transaction value in association with information about the at least one identified product of interest and the at least one identified provider to a user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing system for autonomous product value negotiations.

FIG. 2 is an exemplary block diagram illustrating a plurality of databots for autonomously performing crowd sourced value negotiations.

FIG. 3 is an exemplary block diagram illustrating a databot negotiation environment.

FIG. 4 is an exemplary flow chart illustrating operation of the databot computing device to perform value negotiations.

FIG. 5 is an exemplary flow chart illustrating operation of the databot computing device to analyze sensor data to identify a product of interest.

Corresponding reference characters indicate corresponding parts throughout the drawings.

### DETAILED DESCRIPTION

Referring to the figures, examples of the disclosure enable autonomous value negotiations for products. In some examples, a databot obtains data associated with a user from a plurality of data sources. The plurality of data sources includes sensor data from a set of sensors, user preference data and/or values data from a database of user provided data, history data from a product history database, values data from a user values database, and/or other data sources associated with the user. The set of sensors includes one or more cameras, microphones, or other sensor devices for gathering sensor data associated with a detection area. The detection area may include an area within a user's home, automobile, yard, workplace, or other environment selected by the user. This enables the databot to efficiently obtain accurate data associated with the user in real time.

In other examples, the databot analyzes data received from the plurality of data sources associated with the user to identify an activity of interest to a user. An activity of interest to a user may include a hobby, sport, task, chore, job, or any other activity engaged in by the user or otherwise of interest to the user. The databot analyzes data from the plurality of data sources to identify an activity of interest to the user with minimal or no input from the user. This automatic analysis minimizes user interactions with the system during identification of the activity to improve user efficiency.

In still other examples, the databot system autonomously negotiates with a provider of one or more items associated with the identified activity to obtain a negotiated rate for provision of the product to the user. A product may be a physical item or a service. A provider may be a retailer, manufacturer, vendor, supplier, restaurant, cleaning service, landscaping service, delivery service, or any other type of provider of goods or services.

The autonomous negotiation system in some examples enables the system to negotiate for products of potential interest to the user with minimal user involvement in the analysis, search, and negotiation process to improve user efficiency via user interface (UI) interactions and increase customer satisfaction associated with product transactions.

The databot device coordinates with one or more other databot devices negotiating for the same product to generate a crowd-sourced demand for the product in some examples. This crowd-sourced demand for the product decreases price and improves overall negotiated transaction value for the individual user purchasing the product. This automated negotiation system further lowers costs of products and services valued by users.

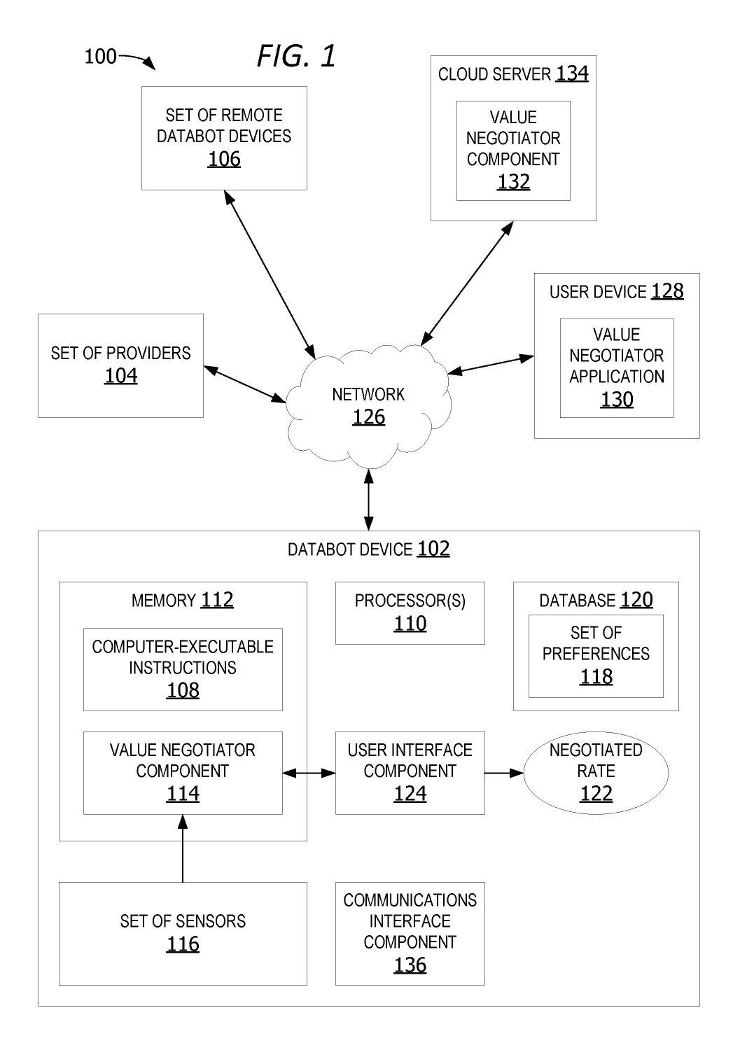

Referring again to FIG. 1, an exemplary block diagram illustrating a computing system 100 for autonomous product value negotiations is shown. In the example of FIG. 1, the databot device 102 communicating with a set of providers 104 a set of remote databot devices 106, and/or one or more other remote computing devices, represents a system for autonomously performing value negotiations.

The databot device 102 represents a computing hardware device executing computer-executable instructions 108 (e.g., as application programs, operating system functionality, or both) to implement the operations and functionality associated with performing value negotiations. The databot device 102 may be implemented as a computing device, such as, but not limited to, a server, a desktop personal computer, mobile computing device, augmented reality device, a smart speaker device, an Internet of Things (IoT) device, or gaming system. A smart speaker device may be a specialized device including an array of speakers, at least one microphone or audio capture sensor, and a natural language processor, for example.

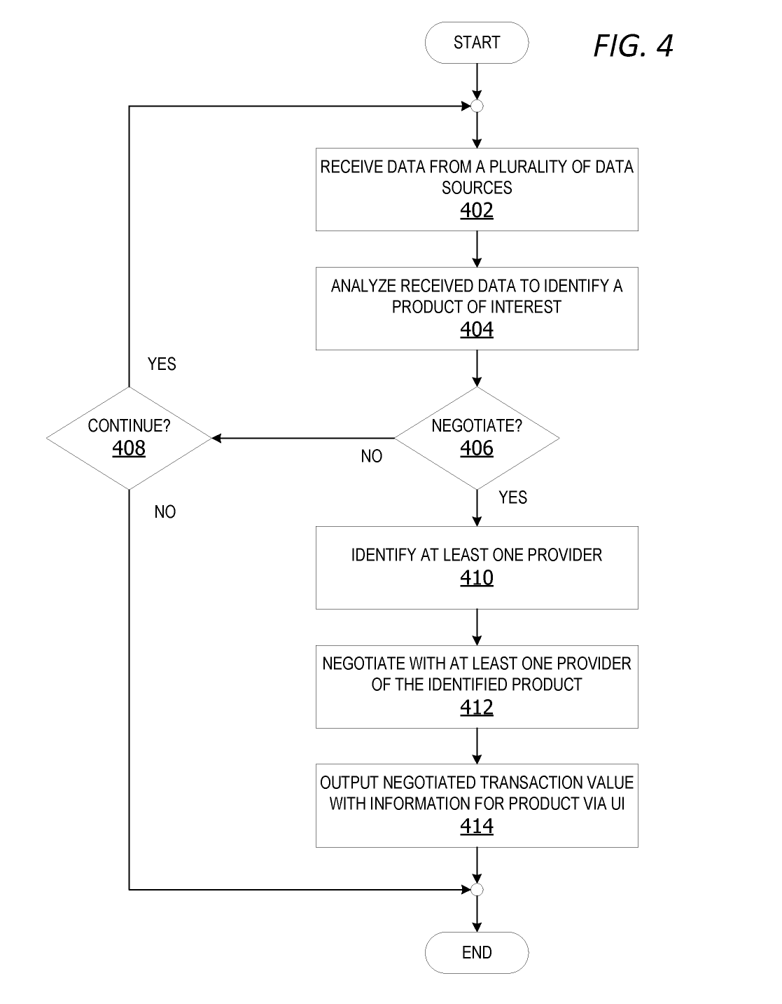

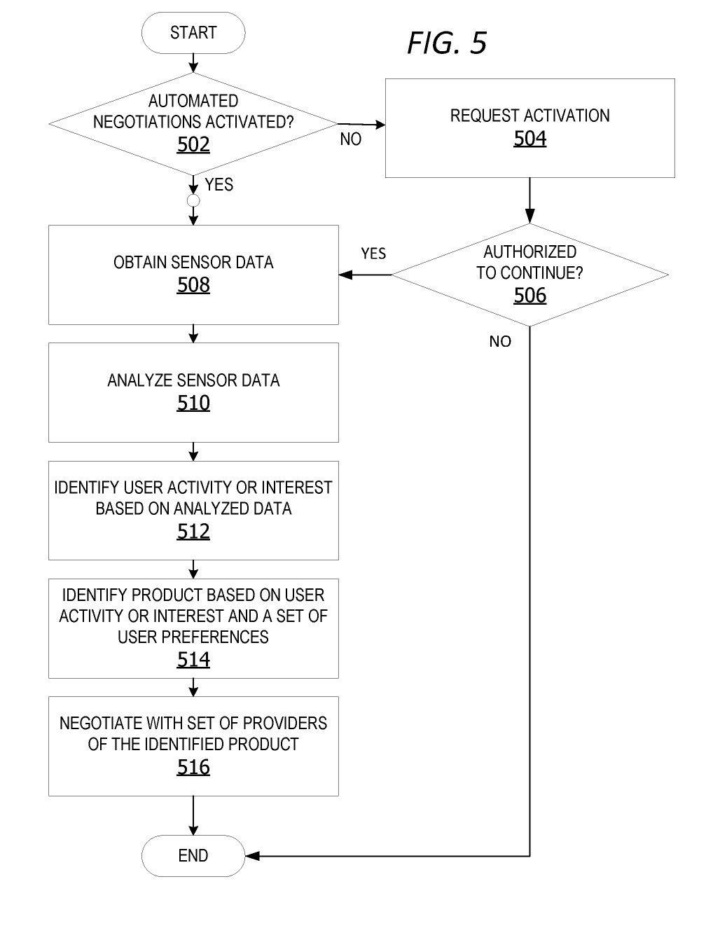

Additionally, the databot device 102 may represent a group of processing units or other computing devices. In some examples, the databot device 102 includes one or more processor(s) 110 and a memory 112. The processor(s) 110 include any quantity of processing units programmed to execute the computer-executable instructions 108. The instructions may be performed by the one or more processor(s) 110 or by one or more processors located externally to the databot device 102. In some examples, the one or more processor(s) 110 are programmed to execute instructions such as those illustrated in the figures (e.g., FIG. 4 and FIG. 5).

The databot device 102 further includes one or more computer readable media, such as the memory 112. The memory 112 includes any quantity of media associated with or accessible by the databot device 102. The memory 112 may be internal to the databot device 102 (as shown in FIG. 1), external to the databot device (not shown), or both (not shown). In some examples, the memory 112 includes read-only memory and/or memory wired into an analog computing device.

The memory 112 further stores a value negotiator component 114. The value negotiator component 114 is a platform agnostic/retailer agnostic, interactive component for performing autonomous value negotiations for products and/or services on behalf of a user. The value negotiator component 114 keeps local data and user data private. In other words, the user owns their personal data in the local databot device. Personal data may include identification data, financial data, fitness data, product history (purchase) data, personal values, health history data, and any other personal information. Personal information may include data associated with family members, demographic information, date of birth, etc.

The value negotiator component 114 determines what data may be sent over the network 126 and which data stays local to the databot device based on user defined parameters. The parameters enable the user to select personal data which may not be sent to providers or other remote computing devices via the network 126. In some examples, the user defined parameters may provide for a subset of personal data that the user allows to be transmitted, while in other examples the user defined parameters may provide that no personal data is to be transmitted.

In this example, the value negotiator component 114 obtains sensor data from a set of sensors 116. The set of sensors 116 may include one or more cameras, one or more microphones, one or more smart devices, a browser, and/or any other sensors for gathering sensor data within a given detection zone of each sensor in the set of sensors. The databot device 102 obtains data from the set of sensors 116 directly from the sensors via a wired connection or via a network connection, such as network 126.

In this example, the set of sensors 116 is located locally or internally to the databot device 102. In other examples, the databot device 102 obtains sensor data from one or more remote sensors located externally to the databot device 102. For example, the databot device 102 may obtain sensor data from a smart television, a smart phone, a smart appliance, a smart thermostat, a vehicle navigation system or global positioning system (GPS) device, a smart microphone system, a web browser, or other sensor device. The databot device 102, in some example, obtains permission from a user prior to obtaining sensor data from a remote sensor. The databot device 102 obtains the sensor data from one or more remote sensors via the network 126.

The value negotiator component 114 analyzes the sensor data to identify an activity or other interest of the user. An activity includes any job, hobby, chore, exercise, routine, or other activity. The value negotiator component 114 identifies a product of potential interest to the user based on the identified activity and a set of preferences 118. The set of preferences 118 is a set of one or more user provided preferences associated with products, identifying products, and/or negotiating for products.

A local data storage device may be associated with the databot device 102. The data associated with the user activity or interest, the set of user preferences 118, user values, user data, and sensor data is stored locally on the local data storage device of the databot device 102, in some examples.

The set of preferences 118 may optionally be stored in a database on a data storage located locally to the databot device 102 or remotely to the databot device.

In some examples, the value negotiator presents the identified products to the user for approval prior to negotiating for the product. If the user approves, the value negotiator autonomously negotiates with one or more providers of the identified products or services. If the user does not approve negotiations for the identified product, the value negotiator component does not identify providers or negotiate for the identified product and/or service. In other examples, the value negotiator automatically negotiates for an identified product without obtaining user approval prior to beginning negotiations.

The value negotiator component 114 identifies a set of providers 104 offering the identified product and/or service. In some examples, the set of preferences may indicate a preferred provider or a non-preferred provider. The set of preferences may also indicate a preferred form or format for products and/or services.

For example, if the value negotiator component 114 analyzes sensor data to determine that the user frequently watches historical dramas and the set of preferences indicates the user prefers to purchase movies rather than rent and the user prefers movies in a digital video disk (DVD) format rather than digital download, the value negotiator component 114 may identify a newly released DVD product detailing the early reign of Queen Victoria as a product of potential interest to the user. The value negotiator component 114 searches a plurality of DVD providers to identify a set of providers offering the identified movie available for purchase in the user's preferred format.

The value negotiator component 114 communicates directly with a provider on behalf of the user to negotiate a lower price for goods or services in some examples. In other examples, the value negotiator component 114 communicates with a third-party platform in the cloud, such as a retailer platform. The third-party platform performs negotiations on behalf of the user.

In some examples, the value negotiator component 114 engages in negotiations with the set of providers 104 via the network 126. The network 126 is implemented by one or more physical network components, such as, but without limitation, routers, switches, network interface cards (NICs), and other network devices. The network 126 may be any type of network for enabling communications with remote computing devices, such as, but not limited to, a local area network (LAN), a subnet, a wide area network (WAN), a wireless (Wi-Fi) network, or any other type of network. In this example, the network 126 is a WAN accessible to the public, such as the Internet.

In some examples the value negotiator component 114 negotiates with one or more of the providers in the set of providers 104 to obtain a negotiated rate 122 for the identified product and/or service. The negotiated rate 122 is a negotiated price, payment plan, rental rate, licensing fee, delivery fee, installation fee, service contract, or other purchase option(s) for obtaining the identified product from one or more providers. The negotiated rate 122 may include a negotiated transaction value. A negotiated transaction value is the price to be paid or the price paid for the identified product and/or service.

In some examples, the value negotiator component 114 negotiates with a single provider in a one databot to one vendor negotiation. In other examples, the value negotiator component 114 negotiates with two or more providers in a one databot to multiple provider negotiation.

The value negotiator component 114 in some examples outputs the negotiated rate 122 with additional information associated with the identified product and/or service to the user. The additional information may include, without limitation, an identification of the product, a review of the product, provider reviews, a product description or other synopsis of the product, identification of the provider, shipping details, manufacturing details, description of services, payment information, warranty information, or other information associated with the product, provider, and/or negotiated rate.

The value negotiator component 114 in some examples outputs the negotiated rate 122 and/or additional information to the user via a user interface (UI) component 124. The UI component 124 optionally includes a graphics card for displaying data to the user and receiving data from the user. The UI component 124 may also include computer-executable instructions (e.g., a driver) for operating the graphics card.

Further, the UI component 124 may include a display (e.g., a touch screen display, projected image, or natural UI) and/or computer-executable instructions (e.g., a driver) for operating the display. The UI component 124 may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way.

In some examples, if the user accepts the negotiated rate, the value negotiator component 114 proceeds with finalizing purchase of the identified product and/or service from one or more providers selected by the user. In other examples, if the user accepts the negotiated rate, the user proceeds with finalizing purchase of the product from one or more providers.

In this example, the value negotiator component 114 performs the analysis and algorithms locally on the databot device 102 for improved data security. The databot device 102 does not communicate with providers or transmit user data via the network 126 without user approval/authorization. Authorization may be provided by a user using an authentication, password, passcode, biometric data, or any other user input for authorization.

The user may authorize the value negotiator component 114 to share the user's values with one or more providers. The user may share the user's values with the databot device and/or provider(s) to facilitate identification of potential products of interest to the user, improve negotiations, and/or achieve greater discounts for those products.

In some examples, the databot device 102 optionally includes a communications interface component 136. The communications interface component 136 includes a network interface card (NIC) and/or computer-executable instructions (e.g., a driver) for operating the NIC. Communication between the databot device 102, the set of providers 104, a remote set of sensors, one or more remote databot devices, as well as any other computing devices may occur using any protocol or mechanism over any wired or wireless connection. In some examples, the communications interface component 136 is operable with short range communication technologies such as by using near-field communication (NFC) tags.

The databot device 102 in some examples is closed to the outside world unless the user gives it permission to communicate and/or negotiate on behalf of the user. The databot device 102 requests permission from the user prior to communicating with one or more providers to negotiate for an identified product and/or service, in this example. If the user fails to authorize the negotiations, the databot device 102 does not negotiate for the identified product or service.

In other examples, the databot device 102 is always authorized to communicate and/or negotiate on behalf of the user in accordance with user defined parameters for communications with providers. The user determines whether to proceed with purchasing a product or service after receiving the negotiated rate.

In still other examples, the databot device is implemented as a mobile computing device, such as user device 128 running a value negotiator application 130. The user device 128 may be implemented as a smart phone, tablet computer, a wearable computing device, such as a smart watch, or other mobile computing device. The user device 128 running the value negotiator application 130 is a databot device. The value negotiator application 130 is an interactive application installed on the user device 128.

In some examples, the value negotiator application 130 analyzes data, such as sensor data, associated with the user to understand the user's values. The value negotiator application 130 observes the user's efforts and identifies products and/or services the user is likely to value. The value negotiator application 130 identifies a product of potential interest to the user based on the user's activities, interests, and/or preferences. The value negotiator application 130 requests permission from the user to begin negotiations for the identified product. If authorized, the user device 128 sends a request for value negotiations to a value negotiator component 132 on a remote cloud server 134.

The value negotiator component 132 running on the cloud goes to the suppliers of the identified product and/or service to negotiate the price of that product or service. The value negotiator running on the cloud platform acts as a cloud proxy. The value negotiator component 132 performs the negotiations with one or more providers in the set of providers 104 to obtain a negotiated rate for the identified product or service.

In some examples, a prioritized list of preferred providers may be selected from the set of providers 104. For example, preferred providers may be pre-selected as part of user preference data. The value negotiator component 132 negotiates with the one or more providers in the prioritized list of preferred providers. If negotiations with the providers in the prioritized list are unsuccessful, the value negotiator component negotiates with providers in the set of providers that are not included in the list of preferred providers.

The cloud platform value negotiator component 132 sends the negotiated rate 122 and additional information associated with the product and/or provider to the value negotiator application running on the user device 128 via the network 126. The user device outputs the negotiated rate to the user.

In some examples, the value negotiator component 132 on the cloud server 134 collects anonymized data to learn about user interests, user values, and real demands. The value negotiator component 132 analyzes data from a plurality of data sources to identify a product of potential interest and performs negotiations to obtain the negotiated rate in response to receiving a request from the value negotiator application 130. The cloud server 134 outputs the negotiated rate and additional information to the value negotiator application 130 for presentation to the user.

The negotiated rate and additional information may be output via an output device associated with the user device 128. The output device may include, without limitation, a speaker, display screen, projected image, or other output device associated with the user device.

The cloud platform value negotiator component 132 includes additional options for data security and/or user privacy. In some examples, the data analyzed by the cloud value negotiator component 132 is anonymized data. The anonymized data lacks user identification or user specific information. In other examples, the value negotiator component 132 includes a two-factor authentication process for user data security.

The cloud server 134 may optionally be implemented as a server associated with a retailer or other provider of goods or services. The cloud server 134 may be a retail platform associated with a particular provider.

In some examples, the value negotiation application 130 is a downloadable application. The value negotiation application 130 may be implemented as a mobile application which is downloaded from a server, such as an application server or a cloud server. For example, the user device 128 may download the value negotiator application from the cloud server 134. In other examples, following download of the application 130, the user sets up a set of preferences using the application 130.

In some example, the sensor data, analyzed data, identified products, purchased products, and other data associated with the autonomous negotiations are stored locally on the databot device 102. In other examples, the data associated with the autonomous negotiations are stored externally to the databot device 102 on a cloud storage or other storage accessible via the network 126.

The value negotiator component 114 running on the databot device 102 in other examples communicates with the value negotiator component 132 on the cloud. The value negotiator component 114 may communicate with the cloud instance of the value negotiator component 132 to facilitate negotiations with one or more providers.

In other examples, the databot device 102 analyzes purchase history data, including information associated with product purchases, returns, rentals, subscriptions, coupons utilized, frequency of purchases, purchase trends, and other transaction data using a predictive analysis engine and machine learning component to algorithmically identify potential new products or services of interest to the user. The set of sensors 116 provide additional real-time data associated with user activities and values to further improve identification of products of interest to the user.

The system 100 shown in FIG. 1 includes a single value negotiator component 132 cloud platform. However, in other examples, each retailer, manufacturer, or other provider in the set of providers 104 may provide a separate cloud platform or a community platform to facilitate negotiations with the client value negotiator.

In this example, the value negotiator application 130 communicates with a value negotiator component 132 on the cloud. The value negotiator on the cloud performs the negotiations. In other examples, the value negotiator application 130 includes the user preference data and sensor data. The value negotiator application 130 performs the analytics to identify a product of interest and negotiate with providers on the user device 128.

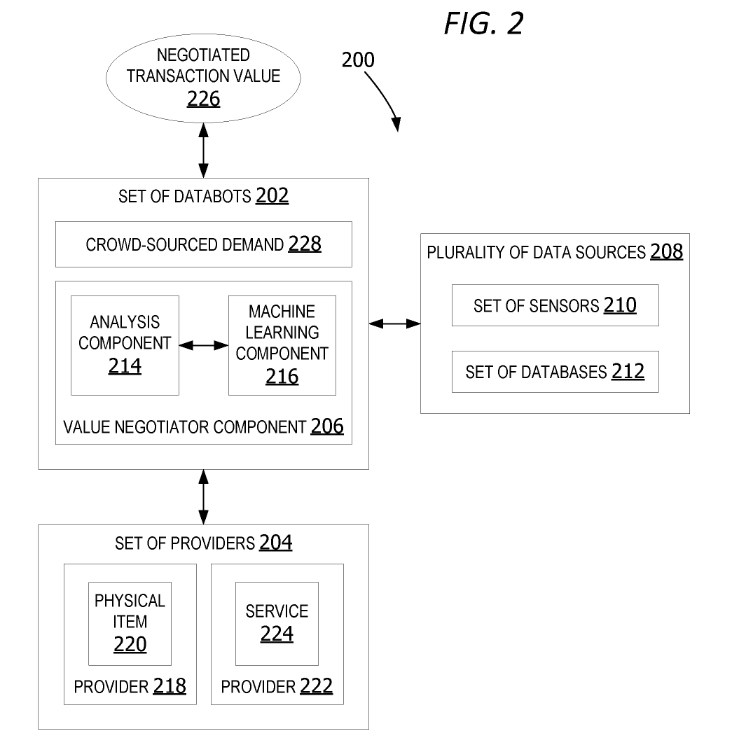

FIG. 2 is an exemplary block diagram illustrating a plurality of databots for autonomously performing crowd sourced value negotiations. The value negotiations system 200 includes a set of one or more databots 202 for performing autonomous value negotiations with a set of providers 204. In some examples, each databot in the set of databot devices is a databot device or other computing device running a value negotiator application. Each databot device is associated with one or more users. The set of databots 202 optionally includes a plurality of databots representing a plurality of users interested in negotiating for the same product from one or more providers.

At least one value negotiator component 206 obtains data from a plurality of data sources 208 associated with at least one user. The plurality of data sources 208 in this non-limiting example includes a set of sensors 210 and a set of databases 212.

The set of sensors 210 and set of databases 212 in this example are located remotely or externally to the set of databots 202. A databot device obtains data from the set of sensors 210 and/or the set of databases 212 via a network. In other examples, one or more sensors and/or one or more databases are located locally to or internally to a databot device.

The set of sensors 210 may include, without limitation, a set of one or more image capture devices, a set of one or more microphones, motions sensors, pressure sensors, light sensors, browsers, mobile devices, facial recognition sensors, infrared sensors, or any other type of sensors.

An image capture device may include a still image camera, a moving image camera, a panoramic camera, an infrared (IR) camera, or any other type of camera. A set of microphones may include a single microphone as well as an array of two or more microphones. The set of sensors may also include smart devices sending data, such as a smart phone or smart appliance.

The set of databases 212 includes one or more databases storing data associated with a user's activities, interests, values, preferences, and/or purchase history. The user's activities may include hobbies, traits, jobs, routines, household chores, exercise, web browsing, and other activities.

The value negotiator component 206 utilizes the data received from the plurality of data sources 208 to observe how a user orders their life. The way the user orders their life indicates the user's values. For example, if a user device includes a number of photos of nature, such as mountains, streams, or bird, but few photos of people, the value negotiator determines the user values nature. Likewise, if a user device includes a number of photos of people but few photos of nature scenes, the value negotiator determines the user values people and relationships rather than nature or inanimate objects. When the user's life is ordered by what the user values, the user experiences greater satisfaction with the value negotiations services provided by the databot devices.

The value negotiator component 206 identifies products and/or services that will allow the user to order their life with less effort. When engaged in negotiations on behalf of the user, the value negotiator keeps things it has learned the user values at a higher priority.

For example, the value negotiator component 206 communicates with sensors, such as smart home appliances, cameras in smart devices, and/or microphones associated with smart devices to obtain the sensor data. The value negotiator analyzes this sensor data to learn the user likes to cook but does not often clean the kitchen after cooking. The value negotiator component 206 understands the user values cooking but does not value cleaning. In this example, the databot device may assist with meal planning, providing meal suggestions and recipes. The databot device may retrieve and output inspirational messages to motivate the user to clean the kitchen after a meal. The value negotiator may also identify products, such as cleaning products or cleaning services, as potential products of interest to the user.

If the user preferences or values indicate the user also values being eco-friendly products, the value negotiator prioritizes providers of eco-friendly cleaning products and/or eco-friendly cleaning services based on the user's preferences and values. On conclusion of negotiations, the databot devices outputs the negotiated price on the cleaning service or cleaning product. The negotiated price may be output in a verbal, natural language format, a textual format, a combination of natural language and text, or any other format.

In some examples, the user selects the data sources in the plurality of data sources accessible to the value negotiator component 206. The user provides access to any or some devices on their personal network or local subnet in their home, vehicle, or other environment associated with a detection zone. The detection zone is an area monitored by one or more sensors in the set of sensors 210 or other area monitored via the plurality of data sources 208.

The value negotiator component 206 provides user selectable settings enabling a user to determine which sensors and/or smart devices within a network or subnet are accessible to the value negotiator for utilization in predicting products of potential interest to the user and/or negotiating with the set of providers 204. The settings are provided to the user via a UI. The UI enables the user to select a configuration for permissible data sources in the plurality of data sources 208 which may be utilized by the value negotiator.

For example, the user may authorize the value negotiator component 206 to utilize all sensors, including all smart devices, available to the value negotiator via the network. The value negotiator in this example may search all devices connected to a home Wi-Fi to access available sensors. Another configuration may permit the value negotiator to utilize smart devices in a home and automobile to learn more about the user. The value negotiator may also utilize stored data, such as photo albums, movie collections, social media, contacts, or other data. If authorized to utilize social media sites, the user provides credentials for accessing one or more social media websites.

The value negotiator component 206 requests access permission from the user prior to accessing data on a mobile device, smart device, or other sensor. In some examples, the value negotiator component 206 only requests permission one time to access data on a given device. This permission provides authorization for the value negotiator to continuously or periodically receive data from that given device. For example, the value negotiator requests permission from the user to periodically obtain video or image data from a mobile device. If granted, the value negotiator is authorized to access periodic views of the user's home or automobile interior via the camera associated with the mobile device.

In other examples, the value negotiator component 206 requests permission each time the value negotiator component wants to obtain data from a particular device. The value negotiator in this example only receives sensor data from a particular sensor, such as a microphone or camera, when the user provides another one-time authorization.

The user may restrict the value negotiator to access a particular device and/or particular applications, databases, or particular type of data on a particular device. For example, if authorized to utilize data on a mobile device, the value negotiator component 206 interrogates all applications on the mobile device to obtain data. If authorized to access only a single application on the device, the value negotiator only interrogates the single authorized application. These applications on the mobile device, such as games, shopping applications, restaurant applications, sports related applications, electronic books, downloaded music, and other applications indicate user interests, hobbies, values, and activities.

The user in another example may authorize the value negotiator to utilize all sensors available on the databot device and accessible via a local network, except the camera on the user's mobile device. A mobile device may include a cellular telephone, tablet PC, smart watch, or other mobile computing device. In another example, the user may authorize the value negotiator to only use data gathered by speakers for natural language processing but no other sensors or sensor data.

An analysis component 214 analyzes the data received from the plurality of data sources 208, such as, but not limited to, sensor data received from the set of sensors 210, and user data received from the set of databases 212. The analysis component 214 identifies a product of predicted interest and/or one or more providers of the identified product. The analysis component 214 predicts one or more products the user is likely to be interested in obtaining based on a forecast demand, user preferences, parameters, current user activities, and other data from the plurality of data sources 208 available to the analysis component.

In some examples, the value negotiator component 206 includes a machine learning component 216. The machine learning component 216 further analyzes user values, activities, purchase trends, and preferences to refine and improve the accuracy of the identification of the product of interest predicted by the value negotiator component 206. The machine learning component 216 does not expose what it has learned during negotiations. The machine learning component 216 uses what it learns about the user to create customized profile(s), patterns, and models to use when searching, identifying products, and/or negotiating on behalf of the user.

A databot device in the set of databots 202 negotiates with one or more providers in the set of providers 204 for provision of the identified product. A provider in the set of providers 204 may include a provider 218 of a physical item 220 and/or a provider 222 of a service 224. For example, a physical item provider may provide cleaning products, such as soap. A service provider may provide cleaning services.

A databot negotiates with one or more providers in some examples to obtain a negotiated rate for the identified product. The negotiated rate may include a negotiated transaction value 226. The negotiated transaction value 226 is the actual price paid or payable for the identified product or service.

The databot negotiates with multiple providers in the set of providers in some examples to obtain a plurality of negotiated rates. The databot selects the provider offering the best negotiated rate. This selected negotiated rate is presented to the user. The best negotiated rate may be the offer with the lowest price, best interest rate, lowest monthly payment, best warrant, or otherwise the most favorable rate for a particular user.

The databot in other examples negotiates with multiple providers to drive down the price of a particular product. The databot uses comparisons between terms offered by different providers to maximize value during negotiations.

In some examples, two or more databots in the set of databots negotiate cooperatively for the same product. This group negotiation by multiple databot devices creates a crowd-sourced demand 228. The multiple databot devices negotiate a value on a product based on the aggregated value of multiple customers.

In some examples, the crowd negotiations include two or more databots communicating together through a private community server. A given databot identifies one or more other databots negotiating for the same product. These two or more databots negotiate with the same provider for a same product. The databots collaborate and/or aggregate their negotiation efforts to drive down the price of a product with a provider through driving demand. The crowd-sourced demand 228 created through a community of databots enables a stronger negotiating position and potentially improves the obtained negotiated transaction value 226, such as by lowering the negotiated price of a product or service.

A secure private network between databots in a community of databots enables communication with the community in which a given user's databot device is only recognized as a unique identifier (ID). This enables the given user to remain anonymous within the community. In these examples, the user provides a unique two-factor authentication to register a databot with the community. A given user's databot device can browse within the community of databots anonymously. The databot device seeks a user's permission for communication within the community. This minimizes the potential for unauthorized access or data breaches.

In some examples, a databot associated with a user analyzes sensor data from the user's movie and music collection in the cloud, photos, and other cloud data authorized by the user. The databot analyzes the data collection to gain information about the user, the user's interest, and activities. The databot device keeps that knowledge local to the databot device. The databot has access to anything the user allows it to mine, search, or analyze. This provides a deeper, richer data set than just shopping patterns. The databot uses the learned information to search and/or negotiate for products on behalf of the user. The databot does not expose what is has learned about the user to other databots or providers without user authorization. The databot is a personalized or customized negotiator bot that learns about the user, negotiates for the user, and keeps the user's personal data private and secure.

In other examples, the value negotiator component 206 analyzes data from the plurality of sources to measure a sales value gap. The sales value gap is a measure of customer needs unmet by a databot device. The sales value gap data is utilized by the machine learning component 216 to improve identification of products of interest and/or improve negotiations for products based on the user's preferences and values.

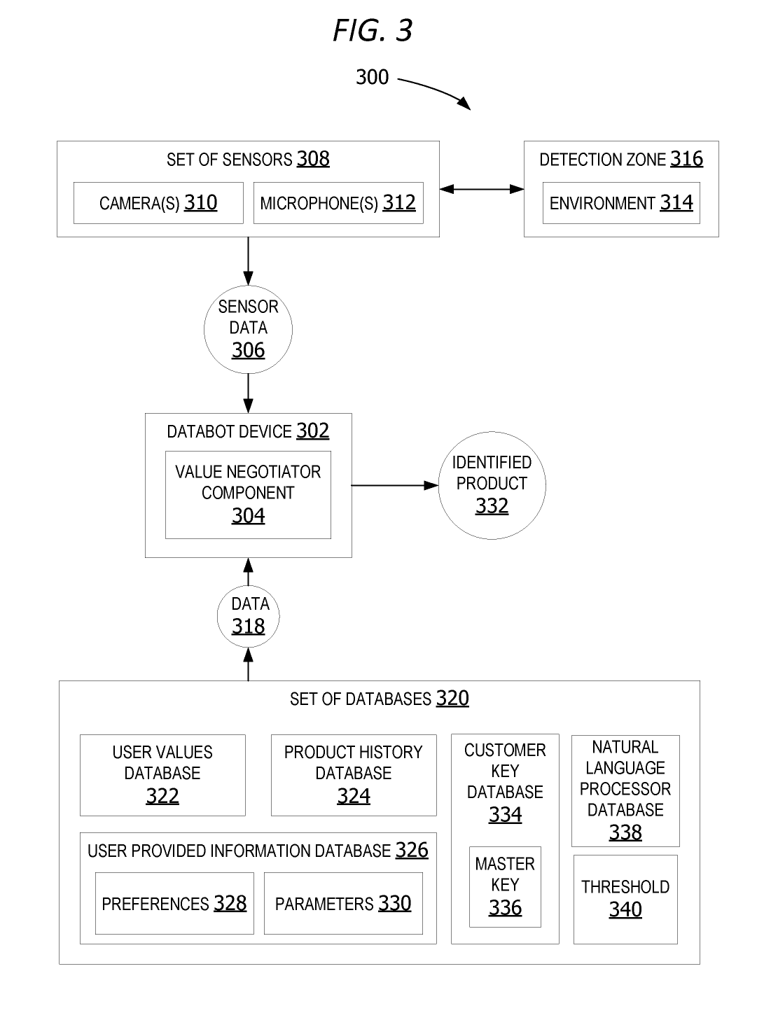

FIG. 3 is an exemplary block diagram illustrating a databot negotiation environment. The autonomous value negotiation system 300 includes a databot device for performing automatic negotiations for one or more identified products. The databot device 302 includes a value negotiator component 304, which may be an illustrative example of one implementation of value negotiator component 206 in FIG. 2. The value negotiator component 304 receives sensor data 306 from a set of sensors 308.

The sensor data 306 is data received from one or more sensors. The sensor data 306 may include image data, audio data, motion data, facial recognition data, temperature data, smart tag data, or any other type of data. The set of sensors 308 may include one or more camera(s) 310 and/or microphone(s) 312. The set of sensors 308 are not limited to cameras and microphones. The set of sensors 308 may also include, without limitation, heat sensors, temperature sensors, smart tag readers, radio frequency identification (RFID) sensors, motion detectors, or any other types of sensors.

For example, the set of sensors may include a smart tag reader. In this example, the databot obtains smart tag data from a plurality of smart tags associated with one or more items within a detection zone via one or more smart tag readers. The databot analyzes the smart tag data to identify an expired product. The expired product may include an expiration date that has passed or an expiration date that will expire within a predetermined time period. The databot identifies a replacement product for the identified expired product. The at least one identified product in this example is the replacement product. In this example, the databot may be authorized to proceed with negotiating for the expired or soon-to-be expired product without obtaining additional user approval prior to negotiating.

In some examples, the set of sensors 308 gather sensor data associated with an environment 314 within a detection zone 316. The detection zone 316 is an area within a sensor range of one or more sensors in the set of sensors 308. The set of sensors detect sound, images, temperature, motion, heat, smart tag transmissions, human speech/natural language, and/or other data within the detection zone 316.

The value negotiator component 304 retrieves data 318 from a set of databases 320. The set of databases 320 includes one or more databases storing data associated with one or more users. The set of databases 320 including a user values database 322. The user values database 322 includes user value data. The user value data including user behavior data, personal traits, hobby data, user interests, preferred activity data, avoided activity data, routine data, value data, and/or habit data. In some examples, the databot analyzes the user value data in the user values database to identify at least one product.

The user value data is data identifying values of the user. For example, a user may value organic, all-natural, and/or environmentally friendly products. In other examples, a user may value sports and physical fitness related products. In still other examples, a user may value supporting the arts.

The set of databases 320 may include a product history database 324. The product history database 324 includes history data for previous products identified by the value negotiator component that were purchased or used by the user, previous products identified by the value negotiator component not purchased by the user, and other product data associated with previous product negotiations and transactions by the user stored locally by the databot device 302.

The set of databases 320 may include a user provided information database 326. The user provided information database 326 includes a set of preferences 328 selected by the user and/or a set of parameters 330. The preferences 328 may include, without limitation, predefined preferences provided by the user related to products, services, or activities of interest, for example. The set of parameters 330 includes one or more rules, restrictions, or other parameters controlling or limiting negotiations performed by the value negotiator component 304 on behalf of the user. In other words, the set of parameters 330 are user defined limitations on disclosure of personal user data associated with the user and stored locally at the databot. The value negotiator component performs negotiations with one or more providers in accordance with the set of parameters 330. A determination on whether to disclose an item of user data to a given provider during negotiations is made by the value negotiator based on the current set of parameters 330.

The set of databases 320 may optionally include a provider database (not shown). Provider data includes data associated with one or more suppliers, manufacturers, retailers, and other vendors of goods and/or services. A provider database may be maintained locally on a given databot device or located remotely to the databot device. A databot device may access a remote database via a network connection.

In some examples, the parameters 330 may be specific to a cloud platform. The parameters may limit or restrict user information disclosed to a provider or value negotiator running on any cloud platform or a particular cloud platform. The parameters 330 may also include permissions defined by the user allowing the value negotiator to disclose user information to a provider or other third parties involved in the negotiations.

In some examples, the set of parameters 330 provide permissions/limitations regarding what user data may be shared or used in the negotiation process with one or more providers. The parameters may be provider specific limiting data to be shared or used with a particular provider. The parameters may be global parameters limiting data to be shared or used during negotiations with any or all providers. For example, a provider specific parameter may permit clothing size information to be shared with a particular clothing retailer. A global parameter may prevent revealing a user's location to any provider.

In still other examples, a user may update the set of parameters 330. An updated set of parameters 330 may change the permissions or restrictions on information sharing. For example, a user may change a parameter to allow sharing of the user's location in order to obtain a discount on a product.

In other examples, a specific provider may request a user share particular personalized data with that provider in exchange for deeper discounts or discounts on items valued by the specific user. The user may authorize the databot device 302 to share anonymized data with the specific provider for potential discounts on products purchased or otherwise obtained from that specific provider.

A provider may request a user share anonymized product history data, such as data associated with shopping, searching, and/or negotiating results, with that provider. In this example, the databot device 302 negotiates with a first provider to obtain a lowest price available for a particular product. The databot device 302 provides anonymized product history data with a different, second provider. The anonymized product history data may be shared in exchange for discounts or other rewards. The second provider may utilize the anonymized product history data associated with other providers to inform on inventory, pricing, and content provided to users.

The user in some examples exposes more personal data to the databot device 302 and/or provider(s) to obtain more assistance from the databot device 302 and/or improved discounts. The user controls the parameters limiting exposure of this personal data. The user determines how the personal data is presented to provider(s). The user may utilize a customer master key 336 to opt-in to the automatic value negotiations services where those services are provided via a retailer platform, cloud platform, or other third-party service provider.

In still other examples, the set of databases 320 includes a customer key database 334 storing one or more encryption keys, such as the customer master key 336. The master key 336 is an encryption key for encrypting user data. In some examples, the master key 336 is received from a given provider. The master key enables automatic authentication of a server associated with the given provider using the master key 336 for that provider. The master key is stored locally on the databot device or on a data storage accessible to the databot device.

In still other examples, the set of databases 320 includes a natural language processor database 338. The value negotiator component utilizes data in the natural language processor database 338 to enable natural language processing. The value negotiator component receives and understands natural language commands and inquiries generated by the user via the natural language processing.

The value negotiator component 304 analyzes the sensor data 306 and/or data 318 from the set of databases 320 to identify a product of potential interest to the user. In some examples, the identified product 332 is output to a user for review. If the user approves negotiations for the identified product 332, the value negotiator component 304 identifies one or more providers of the identified product 332. The value negotiator component 304 commences negotiations for the identified product alone or in combination with one or more other databot devices negotiating for the same product.

The databot device 302, in some examples, utilizes a threshold 340 during negotiations. The threshold 340 may include a user provided value or a default value. The threshold 340 is a value, price, rate, cost, or other value regulating negotiations with one or more providers. The threshold 340 may be utilized by a single databot device as well as two or more databot devices negotiating for the same product cooperatively to create a crowd sourced demand and drive down costs for the product.

In some examples, the threshold 340 is a minimal value at which the databot device begins negotiations. In still other examples, the threshold is a maximum value which the databot device cannot exceed during negotiations. In these examples, the databot device begins negotiations with one or more providers at some value that is below the threshold 340. The databot device has latitude to negotiate with a provider for a product up to a cost or value that is less than or equal to the threshold. In still other examples, the databot device is not authorized to negotiate for a product having a value that equals or exceeds the threshold 340.

In still other examples, the threshold 340 is a value range specifying a maximum value and a minimum value. The value negotiator in this example is authorized to negotiate within the threshold range.

In other examples, the threshold 340 is a percentage value rather than a static dollar amount. In these examples, the databot device analyzes a set of one or more past user purchases. The databot device determines a threshold percentage (x%) below those previous purchases to determine negotiations starting point. The databot device begins negotiations for a product with the threshold 340 of x% below the previous purchases.

In still other examples, the threshold is a low-price threshold indicating a low price desired by a particular user. Each databot in a plurality of databots negotiating in collaboration provides a low-price threshold. At least one databot organizes the low-price thresholds into a threshold list. The threshold list is sorted by the number of users associated with each threshold value. In other words, each threshold value includes an indication of the number of users that have selected that low-price threshold value. The threshold list indicates the percentage of databots supporting each threshold value provided during negotiations for a particular product. In some examples, the databot selects the provider that is able to satisfy the highest percentage of low-price thresholds. In this manner, the databots negotiating together drives down costs and maximizes the value to the largest number of users involved in the crowd-sourced negotiations.

In still other examples, a provider provides mobilized production of a given product. The mobilized production may be provided via a three-dimensional (3D) printer. The 3D printer may a 3D printer device local to the databot device or a 3D printer remote to the databot device. Wherein the 3D printer is remote to the databot device, the product generated by the 3D printer may be shipped to the user or otherwise delivered.

In still other examples, the provider provides plans or a program to operate a 3D printer. The plans and/or program instructs a 3D printer to manufacture the product in accordance with the providers and/or user's specifications.

FIG. 4 is an exemplary flow chart illustrating operation of the databot computing device to perform value negotiations. The process shown in FIG. 4 may be performed by a value negotiator executing on a computing device, such as, but not limited to, the value negotiator component 114 or value negotiator application 130 in FIG. 1, the value negotiator component 206 in FIG. 2, or the value negotiator component 304 in FIG. 3.

The process begins by receiving data from a plurality of data sources at operation 402. Here, a value negotiator, such as the value negotiator component 114 in FIG. 1, receives the data from one or more sources, such as the set of sensors 116 in FIG. 1 or the plurality of data sources 208 in FIG. 2.

The process analyzes the received data to identify a product of interest at operation 404. The value negotiator analyzes the data to identify a product, such as the identified product 332 in FIG. 3.

A determination is made by the value negotiator as to whether to perform a value negotiation at operation 406. The value negotiation is a negotiation with one or more providers of the identified product, such as the provider(s) in the set of providers 104 in FIG. 1. In some examples, the value negotiator determines whether to perform a negotiation based on whether the value negotiator has a user approval or authorization to negotiate with a provider for the identified product. The approval or authorization may be obtained/requested in real-time, or may be determined based on user provided parameters, or both. For example, user-defined parameters may specify that prior approval is required to negotiate for particular products and/or services, or may indicate that pre-authorization is already provided for negotiation of particular products and/or services. If the user does not wish to obtain the identified product, the user may stop negotiations or fail to authorize negotiations for the identified product.

If negotiations are not to be performed at operation 406, a determination is made as to whether to continue at operation 408 or terminate. A determination as to whether to continue may be made based on a user authorization to continue. For example, if the user does not wish to obtain the identified product and the user does not want the value negotiator to attempt to identify another product of potential interest, the process terminates thereafter. However, even if the user does not want to proceed with the first identified product, the user may be interested in permitting the value negotiator to identity and negotiate for one or more other different products in the alternative. In such cases, the user authorizes the value negotiator to continue to operation 408 and iteratively perform operations 402 through 406 to identify one or more other products of potential interest to the user.

Returning to operation 406, when the value negotiator identifies a product for which the user authorizes value negotiations or a product for which negotiations by the value negotiator is pre-authorized, the value negotiator identifies at least one provider of the identified product at operation 410. The value negotiator negotiates with the at least one identified provider of the identified product at operation 412. The value negotiator outputs a negotiated transaction value with information for the product via a UI at operation 414. The process terminates thereafter.

The computing device executing the value negotiator of FIG. 4 may be implemented as a computing device such as, but not limited to, databot device 102, cloud server 134, set of remote databot devices 106, or user device 128 in FIG. 1, the set of databots 202 in FIG. 2, or the databot device 302 in FIG. 3. Further, execution of the operations illustrated in FIG. 4 is not limited to a databot device. One or more computer-readable storage media storing computer-readable instructions may execute to cause at least one processor to implement the operations illustrated in FIG. 4.

While the operations illustrated in FIG. 4 are performed by a computing device or server, aspects of the disclosure contemplate performance of the operations by other entities. For example, a cloud service may perform one or more of the operations. While the example operations provided herein refer to a product of interest, a service of interest may also be identified in a similar manner.

FIG. 5 is an exemplary flow chart illustrating operation of the databot computing device to analyze sensor data to identify a product or service of interest. The process shown in FIG. 5 may be performed by a value negotiator executing on a computing device, such as, but not limited to, the value negotiator component 114 or value negotiator application 130 in FIG. 1, the value negotiator component 206 in FIG. 2, or the value negotiator component 304 in FIG. 3.

The process begins by determining if automated negotiations is activated at operation 502. Here, the determination is made by a value negotiator, such as value negotiator component 114 or the value negotiator application in FIG. 1. The determination may be made based on user parameters, such as the parameters 330 in FIG. 3. For example, the parameters may include a setting allowing automatic negotiations for specific products or services. As another example, user-defined parameters may be in the form of an opt-in or opt-out option, where an opt-in option indicates automated negotiations are activated and an opt-out option indicates automated negotiations are not activated. In examples where automated negotiations are activated, parameters 330 may provide the rules for the negotiation process.

If negotiations are not activated, the process requests activation at operation 504. Activation may be requested via a UI, such as the user interface component 124 in FIG. 1. The process determines whether it is authorized to continue at 506. If the process is not authorized to continue, the process terminates thereafter. If yes, the process obtains sensors data at operation 508. The sensor data may be obtained from one or more sensors, such as sensor(s) in the set of sensors 116 in FIG. 1 or the set of sensors 210 in FIG. 2. If automated negotiations are activated at operation 502, the proceeds to operation 508.

The process analyzes the sensor data at operation 510. The analysis may be performed by an analysis engine and/or a machine learning component, such as analysis component 214 and/or machine learning component 216 in FIG. 2. The process identifies a user activity or interest based on the analyzed data at operation 512. A product is identified based on the user activity or interest and a set of user preferences at operation 514. The user preferences may be retrieved from a database, such as the preferences 328 in the user provided information database 326 in FIG. 3.

The process negotiates with a set of providers of the identified product at operation 516. The set of providers includes one or more suppliers, vendors, manufacturers, or other providers of a product or service, such as the set of providers 104 in FIG. 1 or the set of providers 204 in FIG. 2. The process obtains a negotiated rate associated with the identified product at operation 518. The value negotiator may use the obtained negotiated rate to output an alert to a user interface, including information about the identified product and negotiated rate, and obtain user feedback to the output alert in some examples. The user feedback may be, for example, user interaction with the alert, such as a click-through interaction with the information displayed via the user interface, a transaction associated with the identified product, a dismissal of the alert, or the like. The user interaction feedback may be used by the databot system to improve upon one or more of the identification of user interests, the identification of products or services predicted to be relevant to the user, the identification of providers, and the negotiation process. In some examples, the user feedback may be used by machine learning component 215 to refine one or both of analysis component 214 or value negotiator component 206 in FIG. 2. The process may terminate thereafter.

The computing device executing the process shown in FIG. 5 may be implemented as a computing device such as, but not limited to, databot device 102, cloud server 134, set of remote databot devices 106, or user device 128 in FIG. 1, the set of databots 202 in FIG. 2, or the databot device 302 in FIG. 3. Further, execution of the operations illustrated in FIG. 5 is not limited to a databot device. One or more computer-readable storage media storing computer-readable instructions may execute to cause at least one processor to implement the operations illustrated in FIG. 5.

While the operations illustrated in FIG. 5 are performed by a computing device or server, aspects of the disclosure contemplate performance of the operations by other entities. For example, a cloud service may perform one or more of the operations. Additionally, although a product is described for illustrative purposes, a service may be identified in a similar manner using the operations herein.

### Additional Examples

In some examples, one or more databots perform negotiations for products based on seasonal pricing, seasonal availability of goods or services, and/or increased demand for certain seasonal items. For example, the databot device may negotiate for office supplies in August when the price of school and office supplies are typically lower and/or there is a greater supply and more discounts available for school/office supplies.

In other examples, the databot device negotiates for gardening supplies in the Spring when more users are interested in obtaining gardening supplies. This increased demand improves negotiating leverage and ability to crowd-source negotiations with other databots.

In still other examples, the databot device negotiates for items that are overstock or out of season to obtain an improved negotiated rate. A more desirable negotiated rate may include a lower price for an item. For example, the databot device may negotiate for holiday decorations, such as Christmas lights, in January when these items are still in stock but out of season. The databot leverages the providers desire to move overstock and out-of-season items to obtain an improved negotiated rate.

At least a portion of the functionality of the various elements in FIG. 1, FIG. 2, and FIG. 3 may be performed by other elements in FIG. 1, FIG. 2, and FIG. 3, or an entity (e.g., processor, web service, server, application program, computing device, etc.) not shown in FIG. 1, FIG. 2, and FIG. 3.

In some examples, the operations illustrated in FIG. 4, and FIG. 5 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

Alternatively, or in addition to the other examples described herein, examples include any combination of the following:
the set of sensors includes at least one of an image capture device, a browser, a mobile device, a microphone, a temperature sensor; a facial recognition sensor; an infrared sensor, or a motion sensor;
the set of sensors includes a set of cameras associated with the detection zone, wherein the sensor data comprises images of the environment within the detection zone;
a set of remote databot devices, the databot device communicating with the set of remote databot devices to identify at least one other databot device negotiating with the at least one provider for a same at least one predicted product of interest;
collaborating with the at least one other databot to generate a crowd sourced demand for the at least one predicted product of interest;
a local data storage device associated with the databot device, wherein data associated with the user activity or interest, the set of user preferences, user values, and sensor data is stored locally on the local data storage device of the databot device;
a value negotiator provider platform on a cloud server, wherein the databot device connects to the value negotiator provider platform via a network to engage in negotiations with the at least one identified provider;
retrieving sensor data from the set of cameras, wherein the sensor data comprises images of an environment within a detection zone of the set of cameras;
analyzing user value data in the customer values database to identify the at least one product, the user value data comprising at least one of a user behavior, personal trait, hobby, interest, preferred activity, avoided activity, routine, or habit;
communicating with a set of remote databots to identify at least one other databot negotiating with the same at least one provider for the same at least one identified product;
collaborating with the at least one other databot to generate a crowd sourced demand for the at least one identified product based on the negotiations for the same at least one identified product by the plurality of remote databots, wherein the databot and the at least one other databot perform crowd negotiations for the same identified product;
receiving a set of user defined parameters defining limitations on disclosure of personal user data associated with the user and stored locally at the databot;
negotiating with the at least one provider in accordance with the received set of user defined parameters, wherein a determination on whether to disclose an item of user data to a given provider during negotiations is based on the received set of user defined parameters;
receiving a customer master key;
encrypting user data via the customer master key;
obtaining user value data and sensor data from a set of data sources associated with the user;
obtaining a set of user preferences associated with the user;
analyzing the obtained set of user preferences, the user value data, and the sensor data to identify the at least one product of interest;
communicating with a set of remote databot devices via a network to identify a plurality of databot devices negotiating for the at least one identified product;
identifying one or more providers associated with the at least one identified product in communication with the set of remote databot devices;
determining whether the at least one identified provider is part of the one or more identified providers in communication with the set of remote databot devices;
coordinating negotiations with the at least one identified provider and the set of remote databot devices to generate a crowd sourced demand for the at least one identified product and obtain the negotiated transaction value;
receiving a customer master key from a given provider;
enabling automatic authentication of a server associated with the given provider using the customer master key;
matching the user with a given provider based on at least one of user preferences, availability of the at least one identified product from the given provider, geographic parameters, time parameters, or an available negotiated transaction value;
providing mobilized production of a given product from a given provider via a three-dimensional (3D) printer;
obtaining smart tag data from a plurality of smart tags associated with one or more items within a detection zone;
analyzing the smart tag data to identify an expired product, the expired product having at least one of an expiration date that has passed or an expiration date within a predetermined time period;
identifying a replacement product for the identified expired product, wherein the at least one identified product includes the replacement product;
connecting with a databot negotiator service running on a cloud server; and
transmitting a request to the databot negotiator service to negotiate a transaction value for the at least one identified product, wherein the databot negotiator service communicates with a plurality of databot devices requesting the same at least one identified product and performs crowd negotiations to obtain the negotiated transaction value for the at least one identified product.

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for an autonomous value negotiation system. For example, the elements illustrated in FIG. 1, FIG. 2, and FIG. 3,such as when encoded to perform the operations illustrated in FIG. 4 and FIG. 5, constitute exemplary means for monitoring an environment within a detection zone; exemplary means for obtaining sensor data from the set of sensors; exemplary means for analyzing the sensor data to identify a user activity or interest; exemplary means for generating a prediction of at least one product of interest based on the identified user activity or interest and a set of preferences; and exemplary means for automatically negotiating with at least one provider of the at least one predicted product of interest via a network to obtain a negotiated transaction value for the at least one predicted product of interest.

In still other examples, the elements illustrated in FIG. 1, FIG. 2, and FIG. 3, such as when encoded to perform the operations illustrated in FIG. 4 and FIG. 5, constitute exemplary means for analyzing a plurality of data sources associated with a user to identify at least one activity of interest to a user; exemplary means for retrieving a set of preferences associated with at least one of the user or the at least one identified activity; exemplary means for identifying at least one product associated with the at least one identified activity, the at least one identified product comprising a physical item or a service; and exemplary means for automatically negotiating with at least one provider of the at least one identified product via a network for provision of the at least one identified product to the user at a negotiated rate.

In still other examples, the elements illustrated in FIG. 1, FIG. 2, and FIG. 3, such as when encoded to perform the operations illustrated in FIG. 4 and FIG. 5, constitute exemplary means for monitoring a plurality of data sources associated with a user to identify at least one product of interest to a user, wherein a product comprises a physical item or a service; exemplary means for identifying at least one provider associated with the identified product of interest; exemplary means for automatically negotiating with the at least one identified provider of the at least one identified product of interest to obtain a negotiated transaction value for the at least one identified product; and exemplary means for outputting the obtained negotiated transaction value in association with information about the at least one identified product of interest and the at least one identified provider to a user interface.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for automatically performing value negotiations, the system comprising:
a set of sensors that monitors an environment within a detection zone; and
a databot device, communicatively coupled to the set of sensors, that:
obtains sensor data from the set of sensors;
analyzes the sensor data to identify a user activity or interest;
generates a prediction of at least one product of interest based on the identified user activity or interest and a set of preferences, the at least one predicted product of interest comprising a physical item or a service; and
automatically negotiates with at least one provider of the at least one predicted product of interest via a network to obtain a negotiated transaction value for the at least one predicted product of interest.

2. The system of claim 1, wherein the set of sensors include
at least one of an image capture device, a browser, a mobile device, a microphone, a temperature sensor; a facial recognition sensor; an infrared sensor, or a motion sensor.

3. The system of claim 1, wherein the set of sensors further comprises:
a set of cameras associated with the detection zone, wherein the sensor data comprises images of the environment within the detection zone.

4. The system of claim 1, further comprising:
a set of remote databot devices, the databot device communicating with the set of remote databot devices to identify at least one other databot device negotiating with the at least one provider for a same at least one predicted product of interest; and
collaborating with the at least one other databot to generate a crowd sourced demand for the at least one predicted product of interest.

5. The system of claim 1, further comprising:
a local data storage device associated with the databot device, wherein data associated with the user activity or interest, the set of preferences, user values, and sensor data is stored locally on the local data storage device of the databot device.

6. The system of claim 1, further comprising:
a value negotiator provider platform on a cloud server, wherein the databot device connects to the value negotiator provider platform via the network to engage in negotiations with the at least one identified provider.

7. A method for autonomously negotiating with a provider to obtain a product, the method comprising:
analyzing, by a databot, a plurality of data sources associated with a user to identify at least one activity of interest to a user;
retrieving a set of preferences associated with at least one of the user or the at least one identified activity;
identifying at least one product associated with the at least one identified activity, the at least one identified product comprising a physical item or a service; and
automatically negotiating with at least one provider of the at least one identified product via a network for provision of the at least one identified product to the user at a negotiated rate.

8. The method of claim 7, wherein the plurality of data sources comprises a set of cameras, and further comprising:
retrieving sensor data from the set of cameras, wherein the sensor data comprises images of an environment within a detection zone of the set of cameras.

9. The method of claim 7, wherein the plurality of data sources comprises a customer values database, and further comprising:
analyzing user value data in the customer values database to identify the at least one product, the user value data comprising at least one of a user behavior, personal trait, hobby, interest, preferred activity, avoided activity, routine, or habit.

10. The method of claim 7, further comprising:
communicating with a set of remote databots to identify at least one other databot negotiating with the same at least one provider for the same at least one identified product; and
collaborating with the at least one other databot to generate a crowd sourced demand for the at least one identified product based on negotiations for the same at least one identified product by the plurality of remote databots, wherein the databot and the at least one other databot perform crowd negotiations for the same identified product.

11. The method of claim 7, wherein detecting the user further comprises:
receiving a set of user defined parameters defining limitations on disclosure of personal user data associated with the user and stored locally at the databot; and
negotiating with the at least one provider in accordance with the received set of user defined parameters, wherein a determination on whether to disclose an item of user data to a given provider during negotiations is based on the received set of user defined parameters.

12. The method of claim 7, further comprising:
receiving a customer master key; and
encrypting user data via the customer master key.

13. One or more computer storage devices having computer-executable instructions stored thereon for autonomously negotiating provision of products from a provider, which, on execution by a computer, cause the computer to perform operations comprising:
monitoring, by a databot device, a plurality of data sources associated with a user to identify at least one product of interest to a user, wherein a product comprises a physical item or a service;
identifying at least one provider associated with the identified at least one product of interest;
automatically negotiating with the at least one identified provider of the at least one identified product of interest to obtain a negotiated transaction value for the at least one identified product; and
outputting the obtained negotiated transaction value in association with information about the at least one identified product of interest and the at least one identified provider to a user interface.

14. The one or more computer storage devices of claim 13 having further computer-executable instructions comprising:
obtaining user value data and sensor data from one or more data sources in the plurality of data sources associated with the user;
obtaining a set of user preferences associated with the user; and
analyzing the obtained set of user preferences, the user value data, and the sensor data to identify the at least one product of interest.

15. The one or more computer storage devices of claim 13 having further computer-executable instructions comprising:
communicating with a set of remote databot devices via a network to identify a plurality of databot devices negotiating for the at least one identified product;
identifying one or more providers associated with the at least one identified product in communication with the set of remote databot devices;
determining whether the at least one identified provider is part of the one or more identified providers in communication with the set of remote databot devices; and
coordinating negotiations with the at least one identified provider and the set of remote databot devices to generate a crowd sourced demand for the at least one identified product and obtain the negotiated transaction value.

16. The one or more computer storage devices of claim 13 having further computer-executable instructions comprising:
receiving a customer master key from a given provider; and
enabling automatic authentication of a server associated with the given provider using the customer master key.

17. The one or more computer storage devices of claim 13 having further computer-executable instructions comprising:
matching the user with a given provider based on at least one of user preferences, availability of the at least one identified product from the given provider, geographic parameters, time parameters, or an available negotiated transaction value.

18. The one or more computer storage devices of claim 13 having further computer-executable instructions comprising:
providing mobilized production of a given product from a given provider via a three-dimensional (3D) printer.

19. The one or more computer storage devices of claim 13 having further computer-executable instructions comprising:
obtaining smart tag data from a plurality of smart tags associated with one or more items within a detection zone;
analyzing the smart tag data to identify an expired product, the expired product having at least one of an expiration date that has passed or an expiration date within a predetermined time period; and
identifying a replacement product for the identified expired product, wherein the at least one identified product includes the replacement product.

20. The one or more computer storage devices of claim 13 having further computer-executable instructions comprising:
connecting with a databot negotiator service running on a cloud server; and
transmitting a request to the databot negotiator service to negotiate a transaction value for the at least one identified product, wherein the databot negotiator service communicates with a plurality of databot devices requesting the same at least one identified product and performs crowd negotiations to obtain the negotiated transaction value for the at least one identified product.
